(19) United States
(12) Patent Application Publication
(10) Pub. No.: US 2026/0369600 A1
(43) Pub. Date: Nov. 19, 2026

(54) A COMPOSITE POWDER FOR USE IN THE NEGATIVE ELECTRODE OF A BATTERY, A METHOD FOR PRODUCING SUCH A COMPOSITE POWDER AND A BATTERY COMPRISING SUCH A COMPOSITE POWDER

(71) Applicant: Umicore, Brussels (BE)

(72) Inventors: Kun FENG, Olen (BE); Jean-Sébastien BRIDEL, Olen (BE); Jacob LOCKE, Olen (BE); Cédric VERSPREET, Olen (BE); Brian OOMS, Olen (BE)

(21) Appl. No.: 19/153,654

(22) PCT Filed: Feb. 8, 2024
(86) PCT No.: PCT/EP2024/053149

§ 371 Date: Aug. 5, 2025

(30) Foreign Application Priority Data
Feb. 10, 2023 (EP) 23155996.4

(51) Int. Cl. H01M 4/587; H01M 4/62

(52) U.S. Cl. CPC H01M 4/587; H01M 4/625

(57) ABSTRACT

The present invention relates to a composite powder for use in a negative electrode of a battery, the composite powder comprising composite particles, the composite particles comprising a carbonaceous matrix material with silicon-based particles embedded therein and carbon nanotubes, and wherein the surface of the composite particles is at least partially covered by carbon nanotubes.

### TECHNICAL FIELD AND BACKGROUND

The present invention relates to a composite powder suitable for use in the negative electrode of a battery, a method for producing such a composite powder and a battery comprising such a composite powder.

Lithium ion (Li-ion) batteries are currently the best performing batteries and already became the standard for portable electronic devices. In addition, these batteries now rapidly gain ground in other industries such as automotive and electrical storage. Enabling advantages of such batteries are a high-energy density combined with a good power performance.

A Li-ion battery typically contains a number of so-called Li-ion cells, which in turn contain a positive electrode, also called cathode, a negative electrode, also called anode, and a separator which are immersed in an electrolyte. The most frequently used Li-ion cells for portable applications are developed using electrochemically active materials such as lithium cobalt oxide or lithium nickel manganese cobalt oxide for the cathode and a natural or artificial graphite for the anode.

It is known that one of the important limitative factors influencing a battery's performance and in particular a battery's energy density is the active material in the anode. Therefore, to improve the energy density, the use of electrochemically active materials comprising silicon, in the negative electrode, has been investigated over the past years.

In the art, the performance of a battery containing silicon-based materials is generally quantified by a so-called cycle life of a full-cell, which is defined as the number of times or cycles that a cell comprising such material can be charged and discharged until it reaches 70% of its initial discharge capacity. Most works on silicon-based materials are therefore focused on improving said cycle life.

A drawback of using a silicon-based material in an anode is its large volume expansion during charging, which is as high as 300% when the lithium ions are fully incorporated, e.g. by alloying or insertion, in the anode's active material—a process often called lithiation. The large volume expansion of the silicon-based materials during lithium incorporation may induce stresses in the silicon-based particles, which in turn could lead to a mechanical degradation of the silicon material. Repeated periodically during charging and discharging of the Li-ion battery, the repetitive mechanical degradation of the silicon-based material may reduce the life of a battery to an unacceptable level.

Further, a negative effect associated with silicon-based materials is that a thick SEI, a Solid-Electrolyte Interface, may be formed on the anode. A SEI is a complex reaction product of the electrolyte and lithium, which leads to a loss of lithium availability for electrochemical reactions and therefore to a poor cycle performance, which is the capacity loss per charging-discharging cycle. A thick SEI may further increase the electrical resistance of a battery and thereby limit its ability to charge and discharge at high currents.

In principle, the SEI formation is a self-terminating process that stops as soon as a ‘passivation layer’ has formed on the surface of the silicon-based material. However, because of the volume expansion of silicon-based particles, both silicon-based particles and the SEI may be damaged during discharging (lithiation) and recharging (delithiation), thereby freeing new silicon surface and leading to a new onset of SEI formation.

To solve the above-mentioned drawbacks, composite powders are usually used. In these composite powders, nano-sized silicon-based particles are mixed with at least one component suitable to protect the silicon-based particles from electrolyte decomposition and to accommodate volume changes. Such a component may be a carbon-based material, preferably forming a matrix.

The composite powders usually additionally contain graphitic particles, to adjust their specific capacity to a practical level, between 500 mAh/g and 2000 mAh/g.

Despite the use of such composite powders, there is still room for improvement of the performance of batteries containing silicon-based materials. In particular, the existing composite powders do not allow achieving both a high capacity and a long cycle life, which is essential, in particular for the batteries of the electric vehicles.

It is an objective of the present invention to provide a composite powder comprising composite particles, said composite particles comprising a carbon matrix material with silicon-based particles embedded therein, said composite powder which once used in the negative electrode of a battery, is advantageous in that it allows achieving a high capacity combined to a long cycle life.

### SUMMARY OF THE INVENTION

This objective is achieved by providing a composite powder according to the invention, said composite powder, which once used in the negative electrode of a battery, allows to achieve a long cycle life, while keeping a high specific capacity, as demonstrated in Examples 1 to 11 compared to Counterexample 1.

### DETAILED DESCRIPTION

In the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

In a first aspect, the present invention concerns a composite powder for use in a negative electrode of a battery, the composite powder comprising (i) composite particles, the composite particles comprising a carbonaceous matrix material with silicon-based particles embedded therein, and (ii) carbon nanotubes, wherein the surface of the composite particles is at least partially covered by carbon nanotubes.

The carbon nanotubes may be single-walled carbon nanotubes (SWNT), double-walled carbon nanotubes (DWNT), multi-walled carbon nanotubes (MWNT), or a mixture thereof.

Preferably, the composite particles consist of a carbon matrix material with silicon nanoparticles embedded therein and carbon nanotubes adhering at the surface of the composite particles.

By “carbonaceous matrix material and silicon-based particles embedded therein”, it is meant that the composite particles are, on average, larger in size than the silicon-based particles, since they comprise these latter. The composite particles are typically of micrometric size, while the silicon-based particles are typically of nanometric size. It is also meant that the surface of the silicon-based particles is covered with the carbonaceous matrix material for at least 50% of the surface and preferably that the silicon-based particles are completely covered with the carbon matrix material, to ensure a proper protection against the reaction with the electrolyte during cycling. In other words, the silicon-based particles and the carbon matrix material are not just mixed together, since a proper coverage of the surface of the silicon-based particles cannot be obtained that way. This can be visually confirmed based on the analysis of one or several SEM images of cross-sections of composite particles, comprising the silicon-based particles.

As already mentioned, a negative effect associated with silicon is that a thick SEI, a Solid-Electrolyte Interface, may be formed on the anode, in particular on the silicon-based particles. Since the silicon-based particles are affected by a large volume variation during the lithiation/delithiation process in the battery, the SEI which has already formed might break again, leading to a continuous consumption of lithium and thereby to a dramatic drop of the cycle life of the battery. Protecting the surface of the silicon-based particles with the carbonaceous matrix material, at least partially, is an efficient solution against the continuous formation of the SEI and the loss in cycle life.

The silicon-based particles embedded in the carbonaceous matrix material either form agglomerates of a size smaller than 1 μm or do not for agglomerates at all. Hence, the silicon-based particles are preferably in contact only with each other and/or with the carbonaceous matrix material.

The silicon-based particles may have any shape, e.g. substantially spherical but also irregularly shaped, rod-shaped, plate-shaped, etc. In the silicon-based particles, the silicon is present in its majority as silicon metal, to which minor amounts of other elements may have been added to improve properties, or which may contain some impurities, such as oxygen or traces of metals. When considering a representative number of silicon-based particles, for example not less than 10 distinct silicon-based particles, the average silicon content in such a silicon-based particle is 70 weight % or more, preferably 80 weight % or more, and more preferably 90 weight % or more with respect to the total weight of the silicon-based particle. This can for example be determined by an elemental mapping analysis of a cross-section of a composite particle, comprising numerous cross-sections of silicon-based particles, using a high resolution FEG-SEM microscope. Furthermore, the silicon-based particles typically have a surface layer with an average molar composition SiOₓ with 0≤x<2, and preferably 0≤x<1.

By “the surface of the composite particles is at least partially covered by carbon nanotubes”, it is meant that, when considering pictures of the surface of a representative number of composite particles, for example not less than 10 distinct composite particles, acquired with an electronic microscope, for example a Scanning Electron Microscope (SEM) or a Transmission Electron Microscope (TEM), then at least 1 carbon nanotube on average can be observed per μm² of composite particles surface. Preferably at least 5 carbon nanotubes, more preferably at least 10 carbon nanotubes, particularly preferably at least 20 carbon nanotubes, even more preferably at least 50 carbon nanotubes and utmost particularly preferably at least 100 carbon nanotubes on average can be observed per μm² of composite particles surface.

It is believed by the inventors that the presence of carbon nanotubes at the surface of the composite particles is beneficial in several aspects. Firstly, the presence of carbon nanotubes enhances the electrical conductivity of the composite particles, which is essential to reach both a good cycle life and a high rate capability (ability to be charged fast) in a battery. Other materials can be used for that purpose, such as a carbon layer coating, graphene sheets, etc., however the carbon nanotubes are advantageous in that they have an excellent adherence to the surface and they remain at the surface of the composite particles, even though those latter endure a significant volume expansion/contraction during the charge/discharge cycles of the battery. This is not the case, for example with a carbon layer coating, as the coating will suffer from the mechanical stress induced by the successive volume expansion/contraction cycles, cracks will form and eventually the coating will be rendered useless. The high electrical conductivity of the powder, induced by the presence of carbon nanotubes at the surface of the composite particles, will ensure a high rate capability of the battery comprising the powder. The carbon nanotubes at the surface of the composite particles are preferably single-walled carbon nanotubes (SWNT), because they allow reaching higher electrical conductivity values, compared to double-walled carbon nanotubes (DWNT) or multi-walled carbon nanotubes (MWNT), at similar contents, or similar electrical conductivity values at lower contents. The use of single-walled carbon nanotubes (SWNT) is therefore advantageous in that the content of carbon nanotubes in the composite powder can be reduced, which is beneficial both for the cost of the composite powder and its specific capacity in a battery.

Secondly, the carbon nanotubes at the surface of the composite particles act as a spacer between said particles, thus preventing an agglomeration of the composite particles into an agglomerated powder. In the absence of such a spacer, the agglomerated powder, in order to be used in the negative electrode of a battery, may require a mechanical treatment, such as a grinding step, which might result in a weakening of the integrity of the carbonaceous matrix material and eventually in a reduced cycle life of a battery comprising such an agglomerated powder.

The more coverage of the surface of the composite particles by carbon nanotubes, the stronger the effects previously described, i.e. an enhanced electrical conductivity and a deagglomerated powder. Additionally, the carbon nanotubes forming a covering layer at the surface of the composite particles are also believed to have a beneficial effect on the formation of a stable, conformal, SEI layer, which can better resist the strong mechanical deformation induced by the volume expansion/contraction cycles and thus to lead to an improved cycle life when used as an anode material in a battery.

In another preferred embodiment according to the first aspect of the invention, at least 50% in number, on average, of the carbon nanotubes present in the composite powder are at the surface of the composite particles. As already explained previously, the technical effect is achieved by the presence of carbon nanotubes at the surface of the composite particles. The carbon nanotubes present in other parts of the composite particles, for example in the carbonaceous matrix material, do not contribute to the technical effect, which is not desired. It is therefore preferable that a large majority of carbon nanotubes present in the composite powder are at the surface of the composite particles. It is preferable that at least 60%, more preferably at least 70%, even more preferably at least 80% and particularly preferably at least 90% in number of the carbon nanotubes present in the composite powder are at the surface of the composite particles.

The location of the carbon nanotubes can be assessed, for example, by visual observation, with or without assistance of an image analysis program, of Scanning Electron Microscope (SEM) or Transmission Electron Microscope (TEM) pictures. In particular, SEM and/or TEM pictures of cross-sections of composite particles can be used to detect the presence of carbon nanotubes in the core of the composite particles, for example embedded in the carbonaceous matrix material.

In another preferred embodiment according to the first aspect of the invention, the inventors have determined that a positive effect on performance could already be obtained with a concentration of just 1 carbon nanotube on average per observable μm² of composite particles surface, when considering pictures of the surface of a representative number of composite particles, for example not less than 10 distinct composite particles, acquired with an electronic microscope, for example a Scanning Electron Microscope (SEM) or a Transmission Electron Microscope (TEM). Preferably at least 5 carbon nanotubes, more preferably at least 10 carbon nanotubes, even more preferably at least 20 carbon nanotubes, particularly preferably at least 50 carbon nanotubes and utmost preferably at least 100 carbon nanotubes can be observed on average per μm² of composite particles surface.

Alternatively, the content of carbon nanotubes in the composite powder is at least equal to 0.02 weight percent (wt %), relative to the total weight of the composite powder. The content of carbon nanotubes in the composite powder is preferably at least equal to 0.05 wt %, more preferably at least equal to 0.10 wt %, even more preferably at least equal to 0.20 wt %, particularly preferably at least equal to 0.30 wt % and utmost particularly preferably at least equal to 0.50 wt %, relative to the total weight of the composite powder. On the other hand, since the carbon nanotubes have a very high specific surface, with BET values of several hundreds of m²/g, it is preferable to limit their amount in the composite powder, in order to limit the specific surface of said composite powder. It is preferable to limit the specific surface area of the composite powder to a value of at most 10 m²/g, more preferably at most 8 m²/g and particularly preferably at most 6 m²/g, to limit the surface of electrochemically active particles in contact with the electrolyte in the battery, in order to limit the amount of lithium which is irreversibly consumed in the formation of the SEI layer, and thus to improve the initial coulombic efficiency (1^{st} CE) of a battery containing such a composite powder. The inventors have determined that the content of carbon nanotubes in the composite powder of the invention should preferably be at most 4.0 wt %, relative to the total weight of the composite powder, since with contents exceeding 4.0 wt %, the specific surface area of the composite powder may become too high, with the negative effects previously described. The content of carbon nanotubes in the composite powder of the invention is preferably at most equal to 3.0 wt %, even more preferably at most equal to 2.0 wt %, particularly preferably at most equal to 1.0 wt %, more particularly preferably at most equal to 0.80 wt % and utmost preferably at most equal to 0.60 wt %, relative to the total weight of the composite powder.

The content of carbon nanotubes in the composite powder is preferably comprised between 0.02 wt % and 4.0 wt %, more preferably between 0.05 wt % and 3.0 wt %, even more preferably between 0.05 wt % and 2.0 wt % and particularly preferably between 0.05 wt % and 1.0 wt %, relative to the total weight of the composite powder.

In another embodiment according to the first aspect of the invention, the composite powder, once used as anode material in a battery, has a specific capacity at least equal to 600 mAh/g, more preferably at least equal to 800 mAh/g, even more preferably at least equal to 1000 mAh/g and particularly preferably at least equal to 1200 mA/g. With the necessity to move from thermic vehicles to clean vehicles, in particular to electric vehicles, the main objective to get acceptance from the users is to achieve driving ranges of at least 500-600 km. Since the size and weight of battery packs cannot be extended infinitely, it is necessary to produce batteries with higher energy densities and thus to produce anode materials with higher specific capacities. However, because a high specific capacity also implies more swelling and more mechanical deformations during the charge/discharge cycles, it is preferable to limit the specific capacity of the composite powder to 2600 mAh/g, preferably to 2400 mAh/g, more preferably to 2200 mAh/g and particularly preferably to 2000 mAh/g.

In yet another embodiment according to the first aspect of the invention, the composite powder according to the invention has an electrical conductivity at least equal to 3.0 S/cm and preferably at least equal to 4.0 S/cm, when measured at room temperature, at a pressure of 40 MPa. As already explained, it is necessary for an anode material to have a high electrical conductivity, which in the present invention, is triggered by the presence of carbon nanotubes at the surface of the composite particles. The electrical conductivity may be measured, for example, by a method that is described in the “Analytical methods” section of the present document. Similarly, the composite powder according to the invention has an electrical conductivity at least equal to 1.5 S/cm and preferably at least equal to 2.0 S/cm, when measured at a pressure of 15 MPa, at least equal to 2.5 S/cm and preferably at least equal to 3.5 S/cm when measured at a pressure of 30 MPa, at least equal to 3.5 S/cm and preferably at least equal to 4.5 S/cm when measured at a pressure of 50 MPa and at least equal to 4.0 S/cm and preferably at least equal to 5.0 S/cm when measured at a pressure of 60 MPa, always at room temperature. Even more preferably, the composite powder according to the invention has an electrical conductivity at least equal to 3.0 S/cm when measured at a pressure of 15 MPa, at least equal to 4.5 S/cm when measured at a pressure of 30 MPa, at least equal to 5.0 S/cm when measured at a pressure of 40 MPa, at least equal to 5.5 S/cm when measured at a pressure of 50 MPa and at least equal to 6.0 S/cm when measured at a pressure of 60 MPa, always at room temperature.

In another embodiment according to the first aspect of the invention, the carbonaceous matrix material comprised in the composite powder according to the invention, is soft carbon. Soft carbon corresponds to an arrangement of small disordered graphitic domains that can be converted to graphite upon heating at a temperature of 3000 °C, in opposition to hard carbon which is not graphitizable. Soft carbon shows a higher electronic conductivity compared to hard carbon and is therefore preferable. Furthermore, thanks to its disordered collection of small graphitic domains, which leads to the presence of nanovoids in the matrix material, the volumetric expansion of a particle comprising a matrix material mostly comprising soft carbon, during the lithiation of the anode, is reduced compared to a particle comprising a matrix material mostly comprising graphite or graphene. A reduced volumetric expansion will lead to a longer cycle life in a battery.

In another embodiment according to the first aspect of the invention, the silicon-based particles comprised in the composite powder according to the invention, have a number-based size distribution having a d50, the d50 being larger than or equal to 20 nm and smaller than or equal to 150 nm. The number-based size distribution is based on a visual analysis, with or without assistance of an image analysis program, of a minimum number of silicon-based particles comprised in the composite powder. This minimum number of silicon-based particles is at least 1000 particles. An example of a determination of a number-based distribution of Si-based particles is provided in the “Analytical methods” section.

For the sake of clarity, a d50 of 100 nm for example, would here mean that 50% in number of the at least 1000 silicon-based particles have a size smaller than 100 nm and that 50% in number of the at least 1000 silicon-based particles have a size larger than 100 nm.

Silicon-based particles having a number-based size distribution with a d50 lower than 20 nm are very difficult to disperse efficiently in the carbon matrix material, which may decrease the electronic conductivity of the powder.

Silicon-based particles having a number-based size distribution with a d50 larger than 150 nm are more subject to fractures during their lithiation, causing a dramatic reduction of the cycle life of a battery containing such a composite powder.

It is considered that the d50 is not affected by the process of making the composite powder, which means that the d50 value of the silicon-based powder used as precursor in the process is the same as the d50 value of the silicon-based particles comprised in the composite powder.

In another embodiment according to the first aspect of the invention, the composite particles have a volume-based particle size distribution having a D10, a D50 and a D90, with 1 μm≤D10≤10 μm, 5 μm≤D50≤25 μm and 10 μm≤D90≤40 μm.

For the sake of clarity, a D50 of 15 μm for example, would here mean that 50% in volume of the composite particles have a size smaller than 15 μm and that 50% in volume of the composite particles have a size larger than 15 μm.

Particles of matrix material having a volume-based size distribution with a D50 smaller than 5 μm, may have a too high specific surface and thus increase the surface of reaction with the electrolyte and the formation of SEI, which is disadvantageous for the reasons previously explained. Particles of matrix material having a volume-based size distribution with a D50 larger than 25 μm, may, due to their size, be more susceptible to suffer from the formation of fractures during the lithium uptake, thus leading to a reduced cycle life of the battery containing such particles.

In another embodiment according to the first aspect of the invention, the weight ratio of carbonaceous matrix material over silicon in the composite powder is at most equal to 2.0, preferably at most equal to 1.8, more preferably at most equal to 1.6, further more preferably at most equal to 1.4, even more preferably at most equal to 1.2, particularly preferably at most equal to 1.0 and utmost preferably at most equal to 0.8. Since the carbonaceous matrix material triggers a high irreversible capacity (low coulombic efficiency at first cycle) and a low specific capacity, it is preferable for the composite powder to contain only the amount of carbonaceous matrix material that is necessary to cover the silicon-based particles. Still, a minimum amount of carbonaceous matrix material is necessary to cover the silicon-based particles, therefore the weight ratio of carbonaceous matrix material over silicon in the composite powder is at least equal to 0.5, preferably at least equal to 0.6, more preferably at least equal to 0.7, even more preferably at least equal to 0.8.

In yet another embodiment according to the first aspect of the invention, the composite powder according to the invention further comprises other carbonaceous materials, such as for example graphite particles or graphene particles. Using a mixture of carbon nanotubes and graphene particles, or graphite particles, or a combination of graphene particles and graphite particles, instead of only carbon nanotubes has at least two advantages. Firstly, the presence of graphene particles facilitates the manufacturing process of the composite powder, in particular crushing steps can be performed at lower energy, which decreases the risks of damaging the structure of the composite particles. And secondly, the carbon nanotubes are expensive and therefore it is economically advantageous to replace part of them with graphene particles, or graphite particles, or a combination of graphene particles and graphite particles, in particular if the performance in battery is kept unchanged.

The graphite particles and/or graphene particles are preferably not fully embedded in the carbonaceous matrix material, and more preferably not at all embedded in the carbonaceous matrix material. This can be visually confirmed based on the analysis of one or several SEM images of cross-sections of the composite particles.

The fact that the graphite particles and/or graphene particles are not fully, or not at all embedded in the carbonaceous matrix material is beneficial since only the silicon-based particles need to be covered by the carbonaceous matrix material, hence less carbonaceous matrix material having a high irreversible capacity and a low specific capacity is needed.

Alternatively, the composite powder may also comprise exfoliated graphite particles, expanded graphite particles and/or graphene nanoplatelets, all also preferably not being fully embedded, or not at all embedded in the matrix material, for the same reasons as provided above.

In another embodiment according to the first aspect of the invention, the composite powder according to the invention has a silicon content C expressed in weight percent (wt %), wherein the silicon content is at least equal to 15 wt %, preferably at least equal to 20 wt %, more preferably at least equal to 25 wt % and particularly preferably at least equal to 30 wt %, relative to the total weight of the composite powder. A composite powder having a silicon content inferior to 15 wt % would not meet the requirement in terms of specific capacity of the composite powder, i.e. at least 600 mAh/g. Preferably, the composite powder has a silicon content at most equal to 70 wt % and more preferably at most equal to 60 wt %. A too high silicon content may lead to a too large volume expansion of the silicon-based particles during lithium incorporation, which may induce stresses in the silicon-based particles, which in turn could lead to a mechanical degradation of the negative electrode and consequently to a reduction of the life of a battery comprising such a composite powder to an unacceptable level.

In another embodiment according to the first aspect of the invention, the composite powder according to the invention has an oxygen content D expressed in weight percent (wt %), wherein the oxygen content satisfies D≤0.20×C, C being the silicon content of the composite powder. In other words, the oxygen content in the composite powder is not more than 20 wt % of the silicon content in said composite powder. A composite powder having a too high oxygen content would suffer from an additional irreversible consumption of lithium by the formation of lithium silicate (Li₂SiO₃, Li₄SiO₄) during the first lithiation of the powder, thus increasing the initial irreversible capacity loss of a battery containing such a composite powder.

Preferably, the oxygen content satisfies D≤0.15×C and more preferably D≤0.10×C.

In yet another embodiment according to the first aspect of the invention, the composite powder according to the invention comprises crystalline silicon carbide (SiC) and the ratio of the area of the X-Ray diffraction (XRD) peak attributed to SiC having a maximum at 2θ between 35.0° and 36.0°, to the area of the X-Ray diffraction peak attributed to Si having a maximum at 2θ between 28.0° and 29.0° (ratio “SiC/Si”), when measured with a copper anticathode producing Kα1 and Kα2 X-rays with a wavelength equal to 0.15418 nm, is at most equal to 0.15, preferably at most equal to 0.12, more preferably at most equal to 0.10, even more preferably at most equal to 0.08 and utmost preferably at most equal to 0.06. Because silicon carbide is electrochemically inactive, its presence in the composite powder is not desired, or at least it is preferable to limit its content. Silicon carbide forms during the heat treatment of the “silicon/carbon precursor/carbon nanotubes mixture” and the content of silicon carbide increases with the increase of the heat treatment temperature. This is the reason why the heat treatment temperature should be kept as low as possible, preferably at most 990 °C, and why there should be only one heat treatment step.

In a second aspect, the present invention concerns a method for producing a composite powder. The method comprises the following steps:
a. providing a silicon-based powder, comprising silicon-based particles,
b. mixing said silicon-based powder with a carbon precursor powder capable of decomposing into carbon when heated at a temperature above 900 °C, to obtain a mixture A,
c. dispersing mixture A in a solvent comprising carbon nanotubes, to obtain a mixture B,
d. drying mixture B at a temperature below the temperature of decomposition of the carbon precursor, to obtain a powder A,
e. heating powder A under an oxygen-free atmosphere, at a temperature above 900 °C, to obtain a powder B,
f. crushing and sieving powder B to obtain the final composite powder

The silicon-based powder provided in step a. may be produced by any means, such as for example dry milling, wet milling, plasma synthesis, laser pyrolysis, hot wall reactor synthesis, etc.

The carbon precursor powder mixed in step b. can be any type of carbon precursor, such as for example one, or a mixture of several, of the following materials: polyvinyl alcohol (PVA), polyvinyl chloride (PVC), sucrose, coal-tar pitch, petroleum pitch, lignin, and a resin. Preferably, the carbon precursor decomposes into soft carbon when heated at a temperature above 900 °C. The carbon precursor, when heated at a temperature above 900 °C, preferably has a carbon yield at least equal to 40 wt %—meaning that 40 wt % of the carbon precursor has decomposed into carbon and 60 wt % of the carbon precursor has decomposed into gases—more preferably at least equal to 50 wt % and particularly preferably at least equal to 60 wt %.

The weight ratio “carbon precursor/silicon” is at most equal to 2.0, preferably at most equal to 1.8, more preferably at most equal to 1.6, even more preferably at most equal to 1.4, particularly preferably at most equal to 1.2 and utmost preferably at most equal to 1.0. “silicon” here should be understood as the chemical element silicon, independent from its oxidation state. The carbonaceous matrix material obtained after a heat treatment of the carbon precursor above 900 °C typically having a specific capacity of 200-300 mAh/h, i.e. at least 10 times lower than the specific capacity of silicon, it is preferable to keep the weight ratio “carbon precursor/silicon” as low as possible, but still high enough to have a full embedment and a full coverage of the silicon-based particles in the carbonaceous matrix material. This in order to avoid a direct contact between the silicon-based particles and the liquid electrolyte, triggering the formation of an unstable SEI layer and a decrease of the cycle life of a battery comprising such a composite powder.

In step c., the solvent in which mixture A is dispersed, together with carbon nanotubes, is preferably the same solvent as the one in which the carbon nanotubes are stored. This solvent is preferably water or an alcohol such as ethanol, since it has the advantage of being ecologically friendly, non-toxic and cheap.

The carbon nanotubes used in step c. preferably have an average diameter comprised between 1.0 nm and 5.0 nm, more preferably between 1.5 nm and 4.0 nm. The carbon nanotubes preferably have a specific surface comprised between 300 and 1500 m²/g, more preferably between 500 and 1000 m²/g. Additionally, the carbon nanotubes have an IG/ID ratio in Raman spectroscopy, corresponding to the intensity of the G peak divided by the intensity of the D peak, of at least 5, more preferably of at least 10, even more preferably of at least 20 and particularly more preferably of at least 30. The IG/ID ratio is a good indicator of the amount of carbon material defects; the higher the ratio, the lower the amount of defects and the better the quality of the carbon nanotubes.

It is to be noted that all properties of the carbon nanotubes used in the method for producing the composite powder according to the invention and previously described, remain unchanged during the production of the composite powder and therefore also apply to the carbon nanotubes comprised in the final composite powder.

In step d., the mixture B is dried at a temperature below 200 °C, preferably below 100 °C and preferably under vacuum. Drying equipment that can be used for that purpose are for example vacuum ovens or thin film dryers.

In step e., oxygen-free atmospheres that may be used are for example nitrogen or argon. The temperature at which the powder A is heated is comprised between 900 °C and 1050 °C and preferably comprised between 950 °C and 990 °C. At those temperatures the formation of silicon carbide, which is not desired since it is an electrochemically inactive compound, is limited.

Finally, the crushing of the powder B in step f. should be done at energies as low as possible, to deagglomerate the composite particles, without damaging their structure, which would for example expose the surface of silicon-based particles to contacts with the liquid electrolyte in a battery, followed by the consequences already described earlier.

An alternative method to produce a composite powder containing carbon nanotubes is to start from an existing silicon-carbon composite powder, for example produced by a method described in EP3032616, and to perform the steps c. to f. as described in the method previously described in the present document, i.e. dispersing the composite powder in a solvent comprising carbon nanotubes to obtain a mixture, to dry said mixture at a temperature below 200 °C to obtain a powder C, to heat said powder C under an oxygen-free atmosphere, at a temperature above 900 °C, to obtain a powder D and finally to crush and sieve said powder D to obtain the final composite powder.

However, following this alternative method, the final composite powder has gone twice through a heat treatment step, the first time to produce the composite powder used as precursor and the second time to produce the final composite powder. As explained previously, this will trigger a higher silicon carbide content in the final composite powder produced according to this alternative method, with typically a ratio “SiC/Si” measured by X-Ray diffraction, superior to 0.15, compared to the composite powder produced following the method previously described, which will cause a lower specific capacity and a lower average coulombic efficiency in a battery. Furthermore, although the heart treatment steps are done under an oxygen-free atmosphere, the silicon oxidizes more with two heat treatment than with only one, triggering a higher oxygen content in the composite powder, which will negatively affect the coulombic efficiency at first cycle (1^{st} CE). Thus, this alternative method produces a composite powder with a lower performance in a battery than the composite powder produced according to the method previously described, and is therefore not preferred.

In a third aspect, the present invention concerns the composite powder obtainable by the method according to the second aspect of the invention, previously described. As appreciated by the skilled person all embodiments directed to the composite powder according to the first aspect of the invention and/or the method according to the second aspect of the invention apply mutatis mutandis to the composite powder obtainable by the method according to the invention.

In a fourth aspect, the present invention concerns a negative electrode for a battery, preferably a lithium-ion battery, comprising the composite powder according to the invention. The negative electrode typically also comprises electronically conductive additives, such as carbon black, graphite particles, graphene particles, carbon nanotubes, or a mixture thereof. The content of electronically conductive additives is comprised between 0% and 10% by weight, in particular from 0.1% to 5% by weight, relative to the total weight of the negative electrode layer (excluding the current collector).

It is to be noted that simply adding carbon nanotubes to a negative electrode formulation comprising a composite powder free of carbon nanotubes, would never result in a negative electrode comprising a composite powder according to the present invention, since the carbon nanotubes would be dispersed everywhere throughout the negative electrode instead of being attached to the surface of the composite particles, as it is the case in the present invention.

The negative electrode typically also comprises a binder or a mixture of binders. Specific examples of binders include polysaccharides, lithium-polyacrylate (Li-PAA), sodium polyacrylate (Na-PAA), potassium polyacrylate (K-PAA), polyacrylic acid (H-PAA), sodium carboxymethyl cellulose (Na-CMC), styrene-butadiene rubber (SBR). The binder(s) is/are added to improve the cohesion of the various components of the negative electrode, its mechanical strength on the current collector or even its flexibility properties. The binder(s) represent from 1% to 15% by weight, in particular from 2% to 10% by weight, relative to the total weight of the negative electrode layer (excluding the current collector). An example of a negative electrode preparation is provided elsewhere in this document.

Finally, the present invention also concerns a battery, preferably a lithium-ion battery, comprising a negative electrode according to the present invention, and therefore comprising a composite powder according to the present invention, as previously defined or prepared as previously disclosed. A battery according to the invention more specifically comprises a negative electrode (anode) according to the invention, a positive electrode (cathode) and an electrolyte, preferably a non-aqueous electrolyte. As examples of the positive electrode, mention may be made of the positive electrode active materials selected from LiCoO₂, LiNi_{0.6}Mn_{0.2}Co_{0.2}O₂, LiNi_{0.8}Mn_{0.1}Co_{0.1}O₂, LiNi_{0.8}Co_{0.15}Al_{0.05}O₂, Li_{1.2}Ni_{0.2}Mn_{0.6}O₂, LiFePO₄, and the like. The electrolyte may be preferably a non-aqueous electrolytic solution, a non-aqueous polymer electrolyte or even a solid electrolyte. Specific examples thereof include an organic electrolytic solution obtained by dissolving lithium salt such as LiClO₄, LiPF₆, LiAsF₆, LiBF₄, LiSO₃CF₃, CH₃SO₃Li, CF₃SO₃Li or the like into a non-aqueous solvent such as ethylene carbonate (EC), diethyl carbonate (DEC), dimethyl carbonate (DMC), fluoro ethylene carbonate (FEC), ethyl methyl carbonate (EMC), propylene carbonate (PC), butylene carbonate, acetonitrile, propionitrile, dimethoxyethane, tetrahydrofuran, γ-butyrolactone or the like; a gel polymer electrolyte comprising polyethylene oxide, polyacrylonitrile, polyvinylidene fluoride, polymethyl methacrylate or the like; and a solid polymer electrolyte comprising a polymer having an ethylene oxide bond. Moreover, an additive which causes a decomposition reaction during initial charge of the lithium ion battery may be added to the electrolytic solution. Specific examples of additives include vinylene carbonate (VC), biphenyl, propane sultone (PS), fluoro ethylene carbonate (FEC), ethylene sultone (ES) or the like. The additive amount thereof is preferably not less than 0.1% by weight and not more than 20% by weight, relative to the total weight of the electrolyte.

### BRIEF DESCRIPTION OF THE FIGURES

FIG. 1: SEM picture of composite particles according to the invention (E5). The upper right magnification shows the presence of carbon nanotubes at the surface of the composite particles.

FIG. 2: Comparison of electrical conductivity values measured for composite powders according to the invention and composite powders not according to the invention

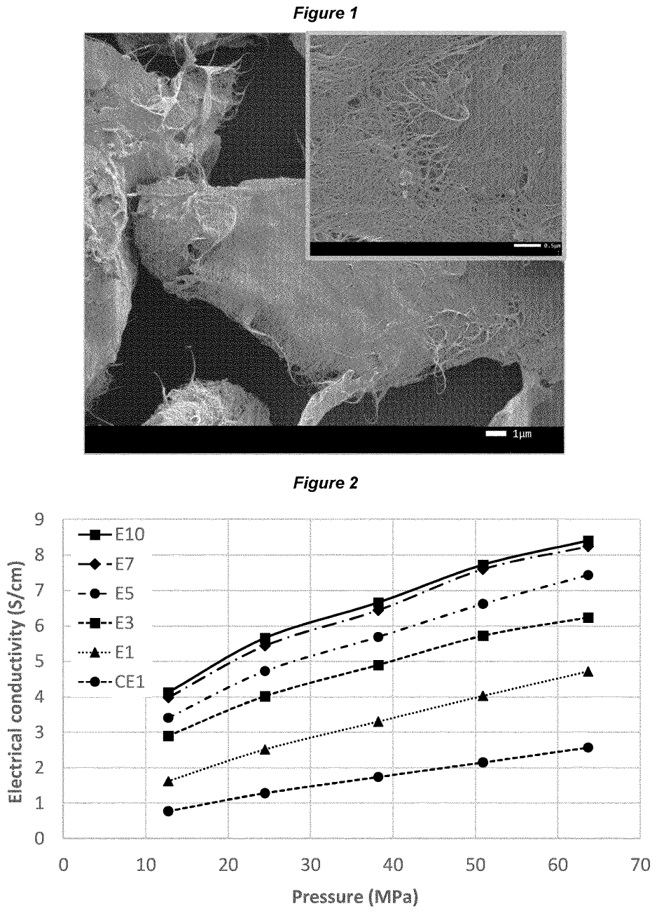

### ANALYTICAL METHODS USED

### Determination of the Silicon Content

The silicon content of the composite powders is measured by X-Ray Fluorescence (XRF) using an energy dispersive spectrometer. This method has an experimental random error of +/−0.3 wt % Si.

### Determination of the Oxygen Content

The oxygen content of the composite powders is determined by the following method, using a LECO TC600 oxygen-nitrogen analyzer. A sample of the powder to be analyzed is put in a closed tin capsule that is put itself in a nickel basket. The basket is put in a graphite crucible and heated under helium as carrier gas to above 2000 °C. The sample thereby melts and oxygen reacts with the graphite from the crucible to CO or CO₂ gas. These gases are guided into an infrared measuring cell. The observed signal is recalculated to an oxygen content.

### Determination of the Carbon Content

The carbon content of the composite powders is determined by the following method, using a Leco CS230 carbon-sulfur analyzer. The sample is melted in a constant oxygen flow in a ceramic crucible in a high frequency furnace. The carbon in the sample reacts with the oxygen gas and leaves the crucible as CO or CO₂. After conversion of an eventual presence of CO into CO₂, all produced CO₂ is finally detected by an infrared detector. The signal is finally converted into a carbon content.

### Determination of the Specific Surface Area (BET)

The specific surface area of the composite powders is measured with the Brunauer-Emmett-Teller (BET) method using a Micromeritics Tristar 3000. 2 g of the powder to be analyzed is first dried in an oven at 120 °C for 2 hours, followed by N₂ purging. Then the powder is degassed in vacuum at 120 °C for 1 hour prior to the measurement, in order to remove adsorbed species.

### Determination of the Electrochemical Performance

The electrochemical performance of the composite powders in the examples and the counterexamples is determined by the following method.

The composite powders to be evaluated are sieved using a 45 μm sieve. Then, in a first stage, the composite powders are tested as such, without any dilution with graphite particles, to determine their specific capacity. They are mixed with carbon black, carbon fibers and sodium carboxymethyl cellulose binder in water (2.5 wt %).

The ratio used is 89 weight parts composite powder/1 weight part carbon black (C65)/2 weight parts carbon fibers (VGCF) and 8 weight parts carboxymethyl cellulose (CMC). All these components are mixed in a Pulverisette 7 planetary ball mill for 30 minutes at 250 rpm.

A copper foil cleaned with ethanol is used as current collector. A 200 μm thick layer of the mixed components is coated on the copper foil. The coated copper foil is then dried for 45 minutes in vacuum at 70 °C. A 1.27 cm² circle is punched from the dried coated copper foil and used as an electrode in a coin cell using lithium metal as counter electrode. The electrolyte is 1M LiPF₆ dissolved in EC/DEC 1/1+2% VC+10% FEC solvents.

All coin-cells are cycled using a high precision battery tester (Maccor 4000 series) using the procedure described below, where “CC” stands for “constant current” and “CV” stands for “constant voltage”.

### Cycle 1:

Rest 6 h
CC lithiation to 10 mV at C/10, then CV lithiation until C/100
Rest 5 min
CC delithiation to 1.5 V at C/10
Rest 5 min

The capacity obtained for the delithiation at cycle 1 is the specific capacity of the composite powder.

In a second stage, the composite powders are tested at a lower capacity, i.e. after dilution with graphite particles in a mixture “composite powder+graphite”. The respective weight contents of composite powder and graphite in the mixture “composite powder+graphite” are adjusted such as to obtain a theoretical specific capacity for said mixture of about 550 mAh/g. For example, for a composite powder having a measured specific capacity of 1500 mAh/g and using a theoretical capacity of 350 mAh/g for the graphite, the respective weight contents of composite powder and graphite are respectively 17.4 wt % and 82.6 wt %. The rest of the procedure, anode formulation, cell composition and cell assembling, is kept unchanged.

The cycling procedure is as follows:

### Cycle 1:

Rest 6 h
CC lithiation to 10 mV at C/10, then CV lithiation until C/100
Rest 5 min
CC delithiation to 1.5 V at C/10
Rest 5 min

### From Cycle 2 on:

CC lithiation to 10 mV at C/2, then CV lithiation until C/50
Rest 5 min
CC delithiation to 1.2 V at C/2
Rest 5 min

The coulombic efficiency (CE) of the coin-cell, being the ratio of the capacity at delithiation to the capacity at lithiation at a given cycle, is calculated for the initial cycle as well as for the subsequent ones. The initial cycle is the most important one in terms of coulombic efficiency, since the reaction of SEI formation has a huge impact on the CE. Typically for a silicon-based powder the coulombic efficiency at the initial cycle can be as low as 80% (or even lower), corresponding to an irreversible capacity loss for the coin-cell of 20%, which is huge. The target is to reach at least 90% CE at the initial cycle.

For the subsequent cycles even though the CE usually increases well over 99%, the skilled person will be aware that even a small difference in coulombic efficiency per cycle, will have, over the hundreds or thousands of charging-discharging cycles a battery is expected to last, a significant cumulative effect. To give an example, a cell with an initial capacity of 1 Ah having an average CE of 99.8% will, after 100 charging-discharging cycles, have a remaining capacity of 0.8 Ah, which is 60% higher than for a cell having an average CE of 99.5% (remaining capacity of 0.5 Ah).

The target in terms of average CE from cycle 5 to cycle 50 is to reach at least 99.75%, preferably at least 99.80%, and even more preferably at least 99.85% for a cell comprising a negative electrode material (i.e. a mixture of the composite powder and carbon additives, such as graphite or graphene) with a specific capacity of 550±10 mAh/g.

### Determination of the Number-Based Particle Size Distribution

The number-based particle size distribution of the silicon-based particles is determined via an electron microscopy analysis (SEM or TEM) of a cross-section of the composite powder, combined with an image analysis.

To do this, a cross-section of the composite powder, comprising multiple cross-sections of composite particles, each of them comprising multiple cross-sections of silicon-based particles, is prepared following the procedure detailed hereunder.

500 mg of the composite powder to be analyzed is embedded in 7 g of a resin (Buehler EpoxiCure 2) consisting of a mix of 4 parts Epoxy Resin (20-3430-128) and 1 part Epoxy Hardener (20-3432-032). The resulting sample of 1″ diameter is dried during at least 8 hours. It is then polished, first mechanically using a Struers Tegramin-30 until a thickness of maximum 5 mm is reached, and then further polished by ion-beam polishing (Cross Section Polisher Jeol SM-09010) for about 6 hours at 6 kV, to obtain a polished surface. A carbon coating is finally applied on this polished surface by carbon sputtering using a Cressington 208 carbon coater for 12 seconds, to obtain the sample, also called “cross-section”, that will be analyzed by SEM.

The prepared cross-section is then analyzed using a FEG-SEM JSM-7600F from JEOL equipped with an EDS detector Xflash 5030-127 from Bruker (30 mm², 127 eV). The signals from this detector are treated by the Quantax 800 EDS system from Bruker.

The enlargements are generated by applying a voltage of 15 kV at a working distance of several millimeters. The images from the backscattered electrons are reported when adding value to the images from the optical microscope.

The size of a silicon-based particle is considered to be equivalent to the maximum straight-line distance between two points on the perimeter of a discrete cross-section of that silicon-based particle.

For the purpose of illustrating, in a non-limitative way, the determination of the number-based particle size distribution of silicon-based particles, a SEM-based procedure is provided below.
1. Multiple SEM images of the cross-section of the composite powder comprising composite particles with silicon-based particles dispersed therein, are acquired.
2. The contrast and brightness settings of the images are adjusted for an easy visualization of the cross-sections of the composite particles and the silicon-based particles. Due to their different chemical composition, the difference in brightness allows for an easy distinction between both types of particles.
3. At least 1000 discrete cross-sections of silicon-based particles, not overlapping with another cross-section of a silicon-based particle, are selected from one or several of the acquired SEM image(s), using a suitable image analysis software. These discrete cross-sections of silicon-based particles can be selected from one or more cross-sections of the composite powder comprising the composite particles and the silicon-based particles.
4. The size of the discrete cross-sections of the silicon-based particles are measured using a suitable image analysis software for each of the at least 1000 discrete cross-sections of silicon-based particles.

The d10, d50 and d90 values of the number-based particle size distribution of silicon-based particles, determined using the method described above, are then calculated. These number-based particle size distributions can be readily converted to a weight- or a volume-based particle size distribution via well-known mathematical equations.

### Determination of the Volume-Based Particle Size Distribution

The volume-based particle size distribution of the composite particles is determined with a laser diffraction particle size analyzer Malvern Mastersizer 2000. The following measurement conditions are selected: compressed range; active beam length 2.4 mm; measurement range: 300 RF; 0.01 to 900 μm. The sample preparation and measurement are carried out in accordance with the manufacturer's instructions.

### Determination of the Electrical Conductivity Values

The electrical conductivity of the composite powders is determined at room temperature using the 4-point probe method with a powder resistivity measurement system Nittoseyko Analytech MCP-PD51. For each sample, 5 measurements are performed at loads of 4 kN, 8 kN, 12 kN, 16 kN and 20 kN.

### Determination of the Ratio “SiC/Si”

The ratio SiC/Si is determined using an X-ray Diffraction (XRD) equipment Panalytical ‘X Pert Pro system with a copper anticathode producing Kα1 and Kα2 X-rays and a wavelength λ equal to 0.15418 nm, with a step size of 0.0334° 2θ, a scan rate of about 30 minutes and measuring from 20° to 40° (2θ) on a flattened surface of about 2 cm³ of powder material. The latest version of the ICDD database is used for the identification of present compounds.

The ratio “SiC/Si” corresponds to the ratio of the area of the X-Ray diffraction peak attributed to silicon carbide (SiC) having a maximum at 2θ between 35.0° and 36.0°, to the area of the X-Ray diffraction peak attributed to silicon (Si) having a maximum at 2θ between 28.0° and 29.0°.

### EXPERIMENTAL PREPARATION OF EXAMPLES

### Counterexample 1 (CE1), not According to the Invention

To produce the powder of Counterexample 1, a silicon-based powder is first obtained by applying a 60 kW radio frequency (RF) inductively coupled plasma (ICP), using argon as plasma gas, to which a micron-sized silicon powder precursor is injected at a rate of circa 200 g/h, resulting in a prevalent (i.e. in the reaction zone) temperature above 2000K. In this first process step, the precursor becomes totally vaporized. In a second process step, an argon flow of 20 Nm³/h is used as quench gas immediately downstream of the reaction zone in order to lower the temperature of the gas below 1600K, causing a nucleation into metallic submicron silicon powder. Finally, a passivation step is performed at a temperature of 100 °C during 5 minutes by adding 100 l/h of a N₂/O₂ mixture containing 1 mole % oxygen.

The specific surface area (BET) of the obtained silicon powder is measured to be 83 m²/g. The oxygen content of the obtained silicon powder is measured to be 8.0 wt %. The number-based particle size distribution of the silicon powder is determined to be: d10=52 nm, d50=108 nm and d90=170 nm.

Then, a dry blend is made of 36 g of the obtained silicon-based powder and 60 g of a petroleum-based pitch powder having a softening point of 180 °C. The blend is fed under a nitrogen flow at a feed rate of 500 g/h into a twin-screw extruder, operated at a temperature of 230 °C.

The mixture of the silicon-based powder in pitch thus obtained is cooled under N₂ to room temperature and, once solidified, pulverized and sieved on a 400-mesh sieve, to produce an intermediate powder.

20 g of the obtained intermediate powder 1 are then put in a quartz crucible in a tube furnace, heated up at a heating rate of 3 °C/min to 960 °C, kept at that temperature for two hours and then cooled. All this is performed under an oxygen-free argon atmosphere. In the obtained product, the silicon-based particles are dispersed and embedded in a matrix of soft carbon, resulting from the thermal decomposition of the pitch.

The fired product is finally ball-milled with alumina balls for 1 hour at 300 rpm and sieved over a 325-mesh sieve, to obtain the composite powder of Counterexample 1.

The chemical composition of the composite powder of CE1 and subsequent composite powders are summarized in Table 1.

The total Si content in this powder is measured to be 45.4 wt % by XRF, having an experimental error of +/−0.3 wt %. This corresponds to a calculated value based on a weight loss of the pitch upon heating of circa 35 wt % and an insignificant weight loss upon heating of the other components. The calculated ratio of carbon content resulting from the carbonization of the pitch, forming the matrix material, over the silicon content in the powder is around 1.08. The oxygen content of this powder is measured to be 5.4 wt %. The specific surface area (BET) of the obtained powder is measured to be 2.9 m²/g.

The volume-based particle size distribution of the composite particles obtained has a D10 equal to 5.3 μm, a D50 equal to 15.9 μm and a D90 equal to 24.4 μm.

### Example 1 (E1), According to the Invention

The composite powder of Example 1 (E1) is produced starting from the same intermediate powder as for the production of the composite powder of Counterexample 1 (CE1), i.e. the mixture of the silicon-based powder in pitch. 80 g of the intermediate powder are dispersed in water, together with 13.3 mg of single-walled carbon nanotubes (SWNT) and 20.0 mg of sodium carboxymethyl cellulose (CMC), used as dispersing agent and stirred for 20 minutes. The total solid load in the dispersion thereby obtained is around 40 wt %.

The dispersion is further dried in a vacuum oven at 90 °C for 2 hours, until the water is fully evaporated and a powder is obtained.

20 g of this powder are then put in a quartz crucible in a tube furnace, heated up at a heating rate of 3 °C/min to 960 °C, kept at that temperature for two hours and then cooled. All this is performed under an oxygen-free argon atmosphere. Note that the CMC initially present decomposes, partially into carbon, during the heat treatment, with a carbonization yield of approximately 20%.

In the obtained product, the silicon-based particles are dispersed and embedded in a matrix of soft carbon, resulting from the thermal decomposition of the pitch, and the carbon nanotubes are present at the surface of the particles. The fired product is finally ball-milled with alumina balls for 1 hour at 300 rpm and sieved over a 325-mesh sieve, to obtain the composite powder of Example 1. The content of carbon nanotubes in the composite powder of Example 1 is equal to 0.02 weight % (wt %) relative to the total weight of the composite powder.

### Examples 2, 3, 4, 5, 6 and 7 (E2-E7), According to the Invention

The composite powders of Examples 2 to 7 (E2-E7) are produced using the same method as for the production of the composite powder of Example 1, except for the respective quantities of carbon nanotubes and CMC involved. The content of carbon nanotubes in the final composite powders of Example 2 to 7 is equal to 0.05 wt %, 0.10 wt %, 0.20 wt %, 0.50 wt %, 1.00 wt % and 2.00 wt % respectively, relative to the total weight of the composite powder.

### Example 8 (E8), According to the Invention

The composite powder of Example 8 (E8) is produced using the same method as for the production of the composite powder of Example 7 (E7), except that instead of adding only single-walled carbon nanotubes (SWNT) to the dispersion, a mixture of a reduced amount of SWNT and graphene is used. As already mentioned earlier, it is economically advantageous to replace part of the SWNT, which are expensive, with graphene, in particular if the performance in battery is kept unchanged. The chemical composition of the composite powder E8 is given in Table 1.

### Example 9 (E9), According to the Invention

The composite powder of Example 9 (E9) is produced using the same method as for the production of the composite powder of Example 5 (E5), except that multi-walled carbon nanotubes (MWNT) are used instead of single-walled carbon nanotubes (SWNT).

### Example 10 (E10), Produced Using a Higher Quantity of Carbon Nanotubes

The composite powder of Example 10 (E10) is produced using the same method as for the production of the composite powders of Examples 1 to 7 (E1-E7), except for the quantities of carbon nanotubes and CMC involved. The content of carbon nanotubes in the final composite powder of Example 10 is equal to 5.00 wt %, relative to the total weight of the composite powder.

### Example 11 (E11), Produced Using the Alternative Method

The composite powder of Example 11 (E11) is produced using the alternative method previously described. The composite powder of Counterexample 1 is used as starting material. 80 g of this composite powder CE1 are dispersed in water, together with 0.333 g of single-walled carbon nanotubes (SWNT) and 0.5 g of CMC, used as dispersing agent and stirred for 20 minutes. The total solid load in the dispersion thereby obtained is around 40 wt %.

The dispersion is further dried in a vacuum oven at 90 °C for 2 hours, until the water is fully evaporated and a powder is obtained.

20 g of this powder are then put in a quartz crucible in a tube furnace, heated up at a heating rate of 3 °C/min to 960 °C, kept at that temperature for two hours and then cooled. All this is performed under an oxygen-free argon atmosphere.

The fired product is finally ball-milled with alumina balls for 1 hour at 300 rpm and sieved over a 325-mesh sieve, to obtain the composite powder of Example 11. The content of carbon nanotubes in the composite powder of Example 11 is equal to 0.5 weight % (wt %) relative to the total weight of the composite powder.

TABLE 1
Chemical compositions of the composite powders E1-E11
and CE1. The “C matrix” content corresponds to the content
of carbon resulting from the thermal decomposition of the
carbon precursor (pitch) and the CMC.
Table 1

| | Contents of Si/O/C matrix/ | Ratio “SiC/Si” | Specific |
|---|---|---|---|
| Example | CNT/graphene in the | measured | surface |
| # | composite powder (wt %) | by XRD | area (m²/g) |
| CE1 | 45.4/5.4/49.2/0.00/0.00 | 0.054 | 2.9 |
| E1 | 45.4/5.4/49.2/0.020/0.00 | 0.058 | 3.1 |
| E2 | 45.4/5.4/49.2/0.050/0.00 | 0.059 | 3.2 |
| E3 | 45.3/5.4/49.1/0.10/0.00 | 0.058 | 3.4 |
| E4 | 45.3/5.4/49.1/0.20/0.00 | 0.060 | 3.6 |
| E5 | 45.1/5.4/49.0/0.50/0.00 | 0.062 | 4.5 |
| E6 | 44.9/5.4/48.7/1.00/0.00 | 0.061 | 5.4 |
| E7 | 44.4/5.3/48.2/2.00/0.00 | 0.063 | 6.8 |
| E8 | 44.5/5.3/48.1/0.50/1.50 | 0.061 | 4.9 |
| E9 | 45.1/5.4/49.0/0.50/0.00 | 0.059 | 4.4 |
| E10 | 43.0/5.2/46.8/5.00/0.00 | 0.060 | 11.1 |
| E11 | 44.8/6.1/48.6/0.50/0.00 | 0.176 | 4.8 |

### Determination of the Electrical Conductivity of the Composite Powders

The electrical conductivity of the composite powders is measured according to the method previously described. The results are given in FIG. 2. For a better readability of the Figure, only the results obtained for a selection of composite powders are shown.

### Electrochemical Evaluation of the Composite Powders

The produced composite powders are tested in coin-cells according to the procedure specified above. In a first stage, the composite powders are evaluated as such, i.e. without dilution with graphite particles, to determine their specific capacities. As shown in Table 2, all composite powders have high specific capacities, comprised between 1475 mAh/g and around 1620 mAh/g.

For an easier comparison of their performance, in a second stage, the composite powders are mixed with graphite particles during the electrode preparation, to reach a capacity of the mixture “composite powder+graphite” of around 550+10 mAh/g. The results obtained for the initial coulombic efficiency and the average coulombic efficiency of the coin cells comprising the different composite powders, between cycle 5 and cycle 50, are given in Table 2.

Comparing the results obtained for the composite powders CE1 and E1 to E7, it can be seen that the best results are obtained for the cells containing composite powders comprising carbon nanotubes, for the possible reasons that have been previously given. However, it can also be seen that, (i) although the average coulombic efficiency increases with an increasing content of carbon nanotubes, a plateau of performance is reached for a content of carbon nanotubes comprised between 1.00 wt % and 2.00 wt % and that (ii) increasing the content of carbon nanotubes above 4.00 wt %, as for composite powder E10, although still leading to a high average coulombic efficiency, also leads to a decrease in the specific capacity and in the initial coulombic efficiency, for the possible reasons that have been previously given. A good alternative is to combine carbon nanotubes and graphene, as can be seen by comparing the results obtained with the composite powders E7 and E8.

TABLE 2
Performance of coin-cells containing composite powders E1-E11 and CE1
Table 2

| | | | Average coulombic |
|---|---|---|---|
| | | Initial coulombic | efficiency cycles |
| | Specific | efficiency for | 5-50 for |
| | capacity | “composite | “composite |
| | pure | powders + | powders + |
| | composite | graphite” at | graphite” at |
| Example | powder | 550 ± 10 mAh/g | 550 ± 10 mAh/g |
| # | (mAh/g) | (%) | (%) |
| CE1 | 1622 | 91.15 | 99.72 |
| E1 | 1620 | 91.02 | 99.75 |
| E2 | 1620 | 90.88 | 99.78 |
| E3 | 1618 | 90.82 | 99.81 |
| E4 | 1617 | 90.74 | 99.83 |
| E5 | 1610 | 90.66 | 99.85 |
| E6 | 1604 | 90.45 | 99.86 |
| E7 | 1586 | 90.22 | 99.87 |
| E8 | 1594 | 90.55 | 99.87 |
| E9 | 1610 | 90.72 | 99.80 |
| E10 | 1536 | 88.65 | 99.86 |
| E11 | 1475 | 89.66 | 99.78 |

1-15. (canceled)

16. A composite powder for use in a negative electrode of a battery, the composite powder comprising:
composite particles, the composite particles comprising a carbonaceous matrix material with silicon-based particles embedded therein, and
carbon nanotubes,
wherein the surface of the composite particles is at least partially covered by said carbon nanotubes.

17. The composite powder according to claim 16, further comprising crystalline silicon carbide SiC, the ratio of the area of the X-Ray diffraction peak attributed to SiC having a maximum at 2θ between 35.0° and 36.0°, to the area of the X-Ray diffraction peak attributed to silicon Si having a maximum at 2θ between 28.0° and 29.0°, when measured with a copper anticathode producing Kα1 and Kα2 X-rays with a wavelength equal to 0.15418 nm, being at most equal to 0.15.

18. The composite powder according to claim 16, wherein when considering pictures of the surface of at least 10 distinct composite particles, acquired with an electronic microscope, then at least 1 carbon nanotube in average can be observed per μm² of composite particles surface.

19. The composite powder according to claim 16, wherein the content of carbon nanotubes is at least equal to 0.02 weight %, relative to the total weight of the composite powder.

20. The composite powder according to claim 16, wherein the content of carbon nanotubes is at most equal to 4.00 weight %, relative to the total weight of the composite powder.

21. The composite powder according to claim 16, having a silicon content at least equal to 15 weight %, relative to the total weight of the composite powder.

22. The composite powder according to claim 16, having a specific surface area of at most 10 m²/g.

23. The composite powder according to claim 16, wherein the average content of silicon in the silicon-based particles is 70 weight % or more.

24. The composite powder according to claim 16, wherein the silicon-based particles are characterized by a number-based size distribution having a d50, the d50 being larger than or equal to 20 nm and smaller than or equal to 150 nm.

25. The composite powder according to claim 16, having an electronic conductivity at least equal to 3.0 S/cm, when measured at room temperature at a pressure of 40 MPa.

26. The composite powder according to claim 16, further comprising graphene particles, or graphite particles, or a combination of graphene particles and graphite particles.

27. A method for producing the composite powder according to claim 16, comprising the following steps:
a. providing a silicon-based powder, comprising silicon-based particles,
b. mixing said silicon-based powder with a carbon precursor powder capable of decomposing into carbon when heated at a temperature above 900 °C, to obtain a mixture A,
c. dispersing mixture A in a solvent comprising carbon nanotubes, to obtain a mixture B,
d. drying mixture B at a temperature below the temperature of decomposition of the carbon precursor, to obtain a powder A,
e. heating powder A under an oxygen-free atmosphere, at a temperature above 900 °C, to obtain a powder B, and
f. crushing and sieving powder B to obtain the final composite powder.

28. The method according to claim 27, wherein the silicon-based powder and the carbon precursor are mixed in step b. with a “carbon precursor/silicon” weight ratio at least equal to 0.5 and at most equal to 2.0.

29. A battery comprising the composite powder according to claim 16.
